(19) United States
(12) Patent Application Publication
(10) Pub. No.: US 2026/0034642 A1
(43) Pub. Date: Feb. 5, 2026

(54) POSITIONING DEVICE, PROCESSING APPARATUS, POSITIONING METHOD, AND PROCESSING METHOD

(71) Applicant: Panasonic Intellectual Property Management Co., Ltd., Osaka (JP)

(72) Inventors: Ryo FUJITA, Hyogo (JP); Masaru Hamahira, Fukuoka (JP)

(21) Appl. No.: 19/354,069

(22) Filed: Oct. 9, 2025

Related U.S. Application Data
(63) Continuation of application No. PCT/JP2024/011095, filed on Mar. 21, 2024.

(30) Foreign Application Priority Data
Apr. 19, 2023 (JP) 2023-068559
Apr. 28, 2023 (JP) 2023-075314

(51) Int. Cl. B25B 5/16; G06T 7/73; H04N 23/55; H04N 23/56

(52) U.S. Cl. CPC B25B 5/16; G06T 7/73; H04N 23/55; H04N 23/56; G06T 2207/30204

(57) ABSTRACT

When a prism is disposed between a head and a stage, a half mirror reflects light incident from the direction of the head toward a camera. When the prism is disposed between the head and the stage, another half mirror reflects light incident from the direction of the stage toward the camera. The camera captures a camera image including a first image area, a second image area, and marks on the basis of light incident from the prism. Here, the first image area is image data of the side where the head is located, and the second image area is image data of the side where the stage is located. The marks are provided at positions seen through at least one of the two half mirrors when viewed from the camera.

### CROSS REFERENCE TO RELATED APPLICATIONS

This is a continuation application of PCT International Application No. PCT/JP2024/011095 filed on Mar. 21, 2024, designating the United States of America, which is based on and claims priority of Japanese Patent Application No. 2023-068559 filed on Apr. 19, 2023 and Japanese Patent Application No. 2023-075314 filed on Apr. 28, 2023. The entire disclosures of the above-identified applications, including the specifications, drawings and claims are incorporated herein by reference in their entirety.

### FIELD

The present disclosure relates to, for example, a positioning device used in positioning of, for example, an electronic component, a mounting apparatus including the positioning device, a processing apparatus including the positioning device, a positioning method, a manufacturing method for manufacturing an electronic component, and a processing method.

### BACKGROUND

Conventionally, in manufacturing, for example, an electronic component, the positions of members, such as a substrate and a chip component are identified by using a camera, and positioning of each member is performed. At this time, movement to correct the position deviation of each member is performed according to the position deviation amount recognized by the camera. Here, a movement error can be decreased by minimizing the movement of a head and a stage after the recognition and correction.

For instance, in Patent Literature (PTL) 1, a member is positioned directly above a mounting position on a substrate, and PTL 1 uses an optical system capable of recognizing an alignment mark on the back surface of a member (a first member) held by a head and an alignment mark on the front surface of a member (a second member) held by a stage, the back surface and the front surface being to be connected to each other. Specifically, in PTL 1, the field of view of a camera is vertically divided by a prism, and a vertical misalignment amount is identified on the basis of images captured by an image sensor that are images of the alignment marks on the back surface of the first member and the front surface of the second member which are to be connected to each other. Because of the structure, an error is decreased that occurs when the position of the optical system itself very slightly shifts due to the effects of, for example, vibration and heat.

### CITATION LIST

### Patent Literature

PTL 1: Japanese Patent No. 6663940

### SUMMARY

### Technical Problem

However, in performing positioning with ultra-high precision of less than or equal to 10 μm, a deviation occurs in an optical path due to just a little thermal expansion of some or multiple components, such as a prism, a mirror, and a camera, among the components of an optical system for a first member (e.g., for recognizing a chip component) and an optical system for a second member (e.g., for recognizing a substrate). Thus, the optical path of the optical system for the first member and the optical path of the optical system for the second member no longer share the same axis, which deteriorates the positioning accuracy.

In view of this, the present disclosure provides, for example, a positioning device, a mounting apparatus, a processing apparatus, a positioning method, a manufacturing method for manufacturing an electronic component, and a processing method that are capable of suppressing the positioning accuracy from decreasing.

### Solution to Problem

A positioning device according to an embodiment of the present disclosure is a positioning device that performs positioning of a first component held by a joining head and a second component placed on a stage in mounting the first component onto the second component. The positioning device includes: an optical element including a first half mirror and a second half mirror; a camera; and computation equipment. When the optical element is disposed between the joining head and the stage, the first half mirror reflects light incident from a direction of the joining head toward the camera, when the optical element is disposed between the joining head and the stage, the second half mirror reflects light incident from a direction of the stage toward the camera, the camera is configured to capture a camera image including a first image area, a second image area, and a first mark, based on light incident from the optical element, the first image area being image data of a side where the joining head is located, the second image area being image data of a side where the stage is located, the first mark is provided on at least one of the first half mirror or the second half mirror or is provided at a position seen through at least one of the first half mirror or the second half mirror when viewed from the camera, and the computation equipment determines, based on the camera image, a position of the first component and a position of the second component with a position of the first mark as a reference.

A processing apparatus according to an embodiment of the present disclosure includes: a head; a stage; a positioning device that performs positioning of a first member held by the head and a second member held by the stage in connecting the first member to the second member; an optical element including a first half mirror and a second half mirror; a camera; and computation equipment. When the optical element is disposed between the head and the stage, the first half mirror reflects light incident from a direction of the head toward the camera, when the optical element is disposed between the head and the stage, the second half mirror reflects light incident from a direction of the stage toward the camera, the camera is configured to capture a camera image including a first image area, a second image area, and a first mark, based on light incident from the optical element, the first image area being image data of a side where the head is located, the second image area being image data of a side where the stage is located, the first mark is provided on at least one of the first half mirror or the second half mirror or is provided at a position seen through at least one of the first half mirror or the second half mirror when viewed from the camera, and the computation equipment determines, based on the camera image, a position of the first member and a position of the second member with a position of the first mark as a reference.

### Advantageous Effects

In the present disclosure, it is possible to suppress positioning accuracy from decreasing.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a configuration of a processing apparatus according to Embodiment 1.

FIG. 2 illustrates some of the processes of an operation procedure when the processing apparatus according to Embodiment 1 is used as an imprint apparatus.

FIG. 3 is a side view of a positioning device according to Embodiment 1.

FIG. 4 is a side view of a surrounding portion of a light synthesizing section in the positioning device according to Embodiment 1.

FIG. 5 is a flowchart for explaining an operation of the positioning device according to Embodiment 1.

FIG. 6 is a flowchart illustrating processing for calculating a position correction amount according to Embodiment 1.

FIG. 7 is a figure for explaining the processing for calculating a position correction amount according to Embodiment 1.

FIG. 8 is a side view of a positioning device according to Embodiment 2.

FIG. 9 is a side view of a positioning device according to Embodiment 3.

FIG. 10 is a side view of a positioning device according to Embodiment 4.

FIG. 11 is a side view of a positioning device according to Embodiment 5.

### DESCRIPTION OF EMBODIMENTS

Hereinafter, embodiments of the present disclosure are described with reference to the drawings. It should be noted that each of the embodiments described below indicates a specific example of the present disclosure. Thus, the numerical values, shapes, materials, constituent elements, arrangement and connections of the constituent elements, and other details described in the embodiments below are mere examples, and do not intend to limit the present disclosure. Accordingly, the constituent elements not recited in the independent claims, which indicate superordinate concepts of the present disclosure, among those described in the embodiments below are described as optional constituent elements.

Moreover, in the specification and drawings, the X-axis, the Y-axis, and the Z-axis indicate three axes in a three-dimensional orthogonal coordinate system. The X-axis and the Y-axis are orthogonal to each other, and both axes are orthogonal to the Z-axis. In the embodiments, a Z-axis direction is a vertical direction. It should be noted that the figures are schematic illustrations and are not necessarily precise depictions. Moreover, in the figures, substantially the same elements are assigned the same reference signs, and overlapping explanations are omitted or simplified.

### Embodiment 1

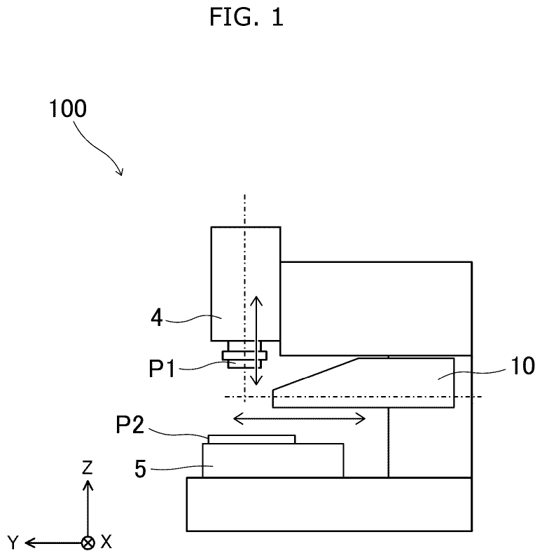

First, processing apparatus 100 according to Embodiment 1 is described with reference to FIG. 1. FIG. 1 illustrates a configuration of processing apparatus 100 according to Embodiment 1.

As illustrated in FIG. 1, processing apparatus 100 includes head 4, stage 5, and positioning device 10.

Head 4 is a holding device that holds first member P1 (a first component). Head 4 can hold first member P1 by, for example, adsorbing or grasping first member P1. Moreover, by being secured with a screw, first member P1 may be held by head 4. Head 4 is movable in a Z-axis direction. Moreover, head 4 is rotatable about a Z-axis. Thus, although not illustrated in the figure, processing apparatus 100 includes a mechanism capable of moving head 4 in the Z-axis direction and rotating head 4 about the Z-axis. Moreover, head 4 may include a mechanism that enables movement in the X-axis direction and a Y-axis direction.

Stage 5 supports second member P2 (a second component). Stage 5 holds second member P2. For instance, by being placed on the top surface of stage 5, second member P2 is held by stage 5. Stage 5 is movable in the X-axis direction and the Y-axis direction. Thus, although not illustrated in the figure, processing apparatus 100 includes a mechanism capable of moving stage 5 in the X-axis direction and the Y-axis direction.

Head 4 may perform a combinational movement including movement in the X-axis direction relative to stage 5, movement in the Y-axis direction relative to stage 5, positioning about the Z-axis, and movement in the Z-axis direction. Moreover, the transfer mechanism may be provided to either head 4 or stage 5, and may be provided to each of head 4 and stage 5.

Positioning device 10 is a positioning mechanism for performing positioning between first member P1 held by head 4 and second member P2 held by stage 5. As with stage 5, positioning device 10 is movable in the X-axis direction and the Y-axis direction. Thus, although not illustrated in the figure, processing apparatus 100 includes a mechanism capable of moving positioning device 10 in the X-axis direction and the Y-axis direction.

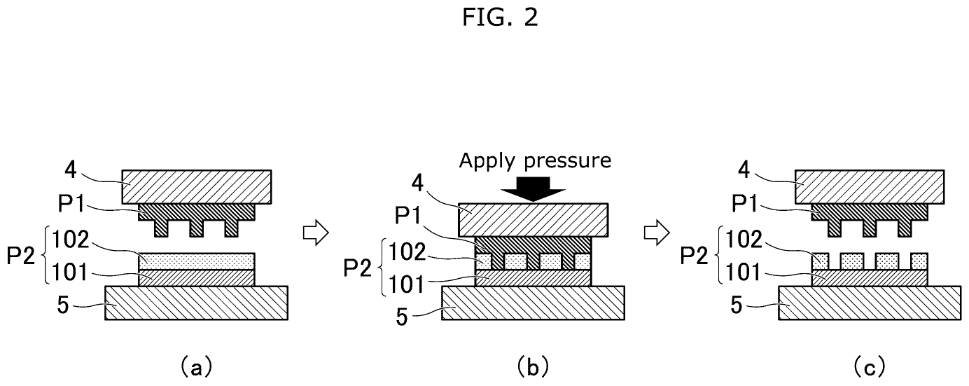

Processing apparatus 100 in Embodiment 1 is an imprint apparatus. For instance, processing apparatus 100 is a nano-imprint apparatus for forming a structure such as a nano-order sized electrode. Here, an operation procedure when processing apparatus 100 is used as an imprint apparatus is described with reference to FIG. 2. FIG. 2 illustrates some of the processes of the operation procedure when processing apparatus 100 according to Embodiment 1 is used as an imprint apparatus.

When processing apparatus 100 is an imprint apparatus, as illustrated in FIG. 2, first member P1 is an imprint mold having a structure with depressions and projections, and second member P2 is a workpiece subjected to imprinting. Second member P2 includes, for example, substrate 101 such as a silicon substrate (wafer) and resin layer 102 disposed above substrate 101.

As illustrated in (a) in FIG. 2, first member P1 is positioned on head 4, and second member P2 is positioned on stage 5. When second member P2 is positioned on stage 5, substrate 101 is placed on stage 5, for instance. Then, a resin material is applied to the top of substrate 101, thereby forming resin layer 102.

Then, the horizontal positions of first member P1 and second member P2 are corrected using positioning device 10. After that, as illustrated in (b) in FIG. 2, head 4 holding first member P1 is moved downward to press the imprint mold, which is first member P1, against resin layer 102 of second member P2. Specifically, the projections of the imprint mold are pressed against resin layer 102 of second member P2.

Then, resin layer 102 is caused to harden in a state where first member P1 is pressed against second member P2. In this case, when the resin material of resin layer 102 is a thermohardening resin, resin layer 102 hardens when heated. Meanwhile, when the resin material of resin layer 102 is a photocurable resin, resin layer 102 is cured when irradiated with light such as ultraviolet light.

Then, as illustrated in (c) in FIG. 2, head 4 holding first member P1 is moved upward to move the imprint mold, which is first member P1, away from second member P2. In this way, openings corresponding to the projections of the imprint mold are formed in resin layer 102.

It should be noted that hardening/curing of resin layer 102 is not limited to hardening/curing performed in a state where first member P1 is pressed against second member P2. Alternatively, hardening/curing of resin layer 102 may be performed after head 4 holding first member P1 is moved upward and the imprint mold, which is first member P1, is moved away from second member P2.

Then, although not illustrated in the figure, a plated film is formed to fill the openings in resin layer 102 by electroless plating. By removing resin layer 102 serving as a resist, it is possible to obtain substrate 101 above which projecting plated electrodes are formed. It should be noted that in this case, to form the metal film, a base electrode such as a seed layer is formed in advance on each of portions of substrate 101 corresponding to the openings in resin layer 102. The plated electrodes formed in this manner can be used as bumps (for example, microbumps). For instance, the substrate including the bumps (plated electrodes) are bump-bonded to a chip component such as a semiconductor chip. In this way, it is possible to obtain an electronic component in which the substrate is bump-bonded to the chip component.

It should be noted that when substrate 101 of second member P2 is, for example, a wafer and is large in comparison with first member P1, processes (a) to (c) in FIG. 2 may be repeated at two or more portions of the wafer under the same condition.

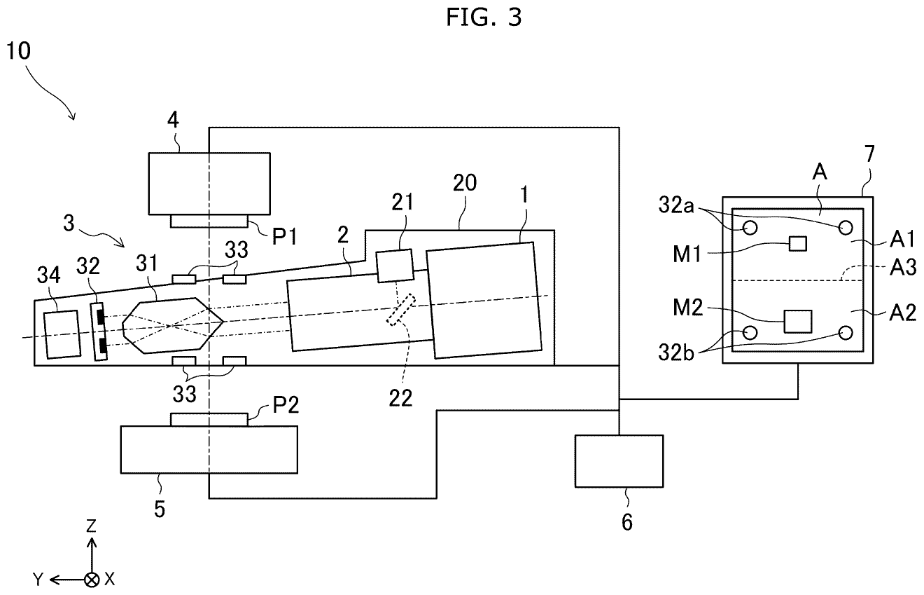

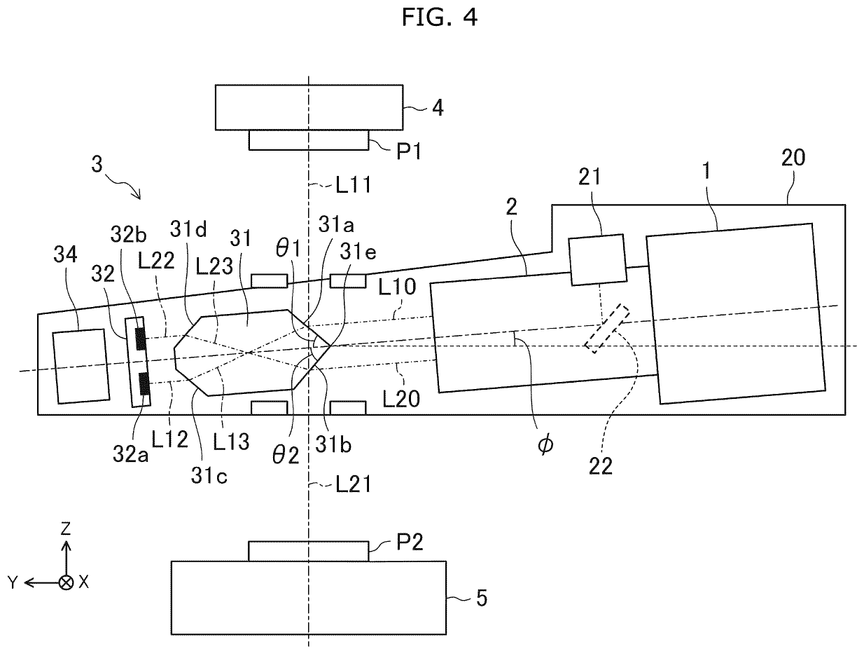

Hereinafter, a detailed configuration of positioning device 10 in processing apparatus 100 according to Embodiment 1 is described with reference to FIGS. 3 and 4. FIG. 3 is a side view of positioning device 10 according to Embodiment 1, and FIG. 4 is a side view of a surrounding portion of a light synthesizing section in positioning device 10 according to Embodiment 1. It should be noted that in the following explanation, the imaging direction of camera 1 (optical axis direction of lens 2) is the Y-direction, a vertical direction is the Z-direction (a first direction), and a direction perpendicular to the Y-direction and the Z-direction is the X-direction.

As illustrated in FIG. 3, positioning device 10 according to Embodiment 1 includes camera 1, lens 2, light synthesizing section 3, head 4, stage 5, computation equipment 6, and monitor 7. It should be noted that in the following explanation, camera 1, lens 2, and light synthesizing section 3 are simply referred to as an optical system. Moreover, when positioning device 10 is used in a mounting apparatus, head 4 is usable as a joining head.

Camera 1 captures, via lens 2 and light synthesizing section 3, an image of first member P1 held by head 4 and an image of second member P2 held by or placed on stage 5 (details are described later). Camera 1 outputs captured camera image A to computation equipment 6. Computation equipment 6 outputs camera image A and a calculation result to monitor 7. Lens 2 is so attached that the optical axis thereof matches the imaging direction of camera 1 (the direction indicated by the long dashed short dashed line in FIG. 3). Lens 2 may be a telecentric optical system with a small positional change even if there is a slight shift in a focus position. However, this does not apply to a case where the accuracy of transferring a workpiece to a focus position is high.

Coaxial lighting device 21 (a first light source) is provided at a top portion of lens 2 in the figure. Coaxial lighting device 21 irradiates first member P1 and second member P2 with light in the Z-direction. Specifically, half mirror 22 is provided at a central portion of lens 2 in the figure. Half mirror 22 transmits light in the imaging direction of camera 1 (the optical axis), whereas half mirror 22 reflects light emitted by coaxial lighting device 21, in the optical axis direction of lens 2. This enables coaxial lighting device 21 to irradiate first member P1 and second member P2 with the light in the Z-direction. It should be noted that coaxial lighting device 21 may be omitted.

It should be noted that each half mirror according to the present disclosure may be a half mirror (for example, a dichroic mirror) that selectively transmits and reflects light on the basis of a wavelength and may be a half mirror (for example, a polarization beam splitter) that transmits and reflects light depending on the polarization direction.

As illustrated in FIG. 4, lens 2 is so disposed that the optical axis thereof has an inclination with angle φ relative to the Y-direction. Specifically, camera 1 and lens 2 are disposed at positions higher than the position of light synthesizing section 3 in the figure. The arrangement can decrease the distance between head 4 and stage 5 when capturing images of first member P1 and second member P2. Thus, it is possible to decrease the amount of movement when connecting first member P1 and second member P2 (here, the amount of movement when head 4 moves toward stage 5). Accordingly, it is possible to decrease an error due to, for example, angle misalignment in the vertical axis of the head caused by, for example, thermal strain.

It should be noted that in Embodiment 1, as a non-limiting example, lens 2 is so disposed that the optical axis thereof has an inclination with angle φ relative to the Y-direction. For instance, when head 4 and stage 5 have heating functions and if there is a need to increase the distance between head 4 and stage 5 when capturing an image, in order to suppress the thermal strain of the optical system, the optical axis of lens 2 may match the Y-direction (that is, angle φ=0).

Moreover, optical holder 20 holds camera 1, lens 2, and light synthesizing section 3 (an optical system). By optical holder 20 holding camera 1, lens 2, and light synthesizing section 3, the optical system can be used as a single unit.

It should be noted that in Embodiment 1, a focusing mechanism for focus adjustment of camera 1 may be provided. For instance, the focusing mechanism may include a drive mechanism that transports camera 1 and lens 2 in the optical axis direction of lens 2.

Light synthesizing section 3 includes prism 31 (an optical element), plate 32, oblique lighting device 33 (a second light source), and auxiliary lighting device 34 (a third light source). Prism 31 and plate 32 are arranged on the optical axis of lens 2 (in the imaging direction of camera 1).

The surface of prism 31 includes half mirror 31a (a first half mirror), half mirror 31b (a second half mirror), and transmissive surfaces 31c and 31d (first transmissive surfaces). Specifically, half mirrors 31a and 31b are formed on the side where camera 1 and lens 2 are positioned, and transmissive surfaces 31c and 31d are formed on the side where plate 32 is positioned. Transmissive surfaces 31c and 31d transmit light incident from the direction of plate 32 toward camera 1 and lens 2.

Half mirror 31a reflects light incident from first member P1 (the direction of head 4) toward camera 1 and lens 2, and transmits light incident from the direction of plate 32 through transmissive surface 31c. Half mirror 31b reflects light incident from second member P2 (the direction of stage 5) toward camera 1 and lens 2, and transmits light incident from the direction of plate 32 through transmissive surface 31d.

An angle formed between half mirror 31a and half mirror 31b is a right angle. Moreover, angle θ1 formed between the optical axis of lens 2 and half mirror 31a is (45+0.5 φ) degrees, and angle θ2 formed between the optical axis of lens 2 and half mirror 31b is (45−0.5 φ) degrees. Because of the above arrangement, it is possible to reflect light rays from first member P1 and second member P2, which are parallel to each other in the Z-direction, toward lens 2 (camera 1) having an optical axis inclined with angle φ relative to the Y-direction.

Plate 32 is disposed on the opposite side from camera 1 and lens 2 relative to prism 31. Marks 32a and 32b (first marks) are provided on the surface of plate 32. Mark 32a is so positioned that light of mark 32a passes through transmissive surface 31c and half mirror 31a and an image of mark 32a is formed on the image sensor of camera 1. Mark 32b is so positioned that light of mark 32b passes through transmissive surface 31d and half mirror 31b and an image of mark 32b is formed on the image sensor of camera 1. By appropriately designing the position and angle of each of half mirrors 31a and 31b and transmissive surfaces 31c and 31d, it is possible to minimize aberration when capturing an image, with regard to marks 32a and 32b formed on one surface of plate 32. Thus, it is possible to obtain satisfactory images of marks 32a and 32b. It should be noted that as illustrated in FIG. 4, although a case where plate 32 has a flat surface is described as a non-limiting example, plate 32 may have a spherical surface, for example. Moreover, marks 32a and 32b need not be provided on the same member, and may be provided on different members, for example. Moreover, as long as images of marks 32a and 32b can be captured, transmissive surfaces 31c and 31d may have any shapes, and may have, for example, a flat surface or a curved surface having an inclination relative to the imaging direction of camera 1 (the optical axis of lens 2). Furthermore, two or more marks are provided on the back surface of plate 32, and a proper mark may be detected according the situation. By providing marks on the front surface (on the same side as lens 2) and the back surface (on the opposite side from lens 2) of plate 32, if aberration occurs due to prism 31, it is possible to deal with the situation.

Oblique lighting device 33 obliquely irradiates first member P1 and second member P2 with light. Auxiliary lighting device 34 irradiates plate 32 with light. Auxiliary lighting device 34 emits light that passes through plate 32 but does not pass through mark 32a or 32b. It should be noted that oblique lighting device 33 and auxiliary lighting device 34 are for assisting the image capturing of camera 1. If camera 1 can clearly capture an imaging target (for example, first member P1), oblique lighting device 33 and auxiliary lighting device 34 need not be provided. Moreover, auxiliary lighting device 34 may have a configuration where light and dark are inversed by making marks 32a and 32b transmissive and the background non-transmissive when camera 1 captures an image. As another configuration, marks 32a and 32b can be irradiated with light by providing auxiliary lighting device 34 at another location, and providing a light guide member such as a mirror at the position of auxiliary lighting device 34 in FIG. 3.

As described above, head 4 holds first member P1, and stage 5 holds second member P2. For instance, when processing apparatus 100 is an imprint apparatus, first member P1 is an imprint mold, and second member P2 is a workpiece including a substrate. First member P1 and second member P2 are picked up by, for example, a feed head (not illustrated), and then held by head 4 and stage 5, respectively. Moreover, when positioning device 10 is used in a mounting apparatus such as a flip chip bonder, first member P1 is a chip component, and second member P2 is a substrate. In this case, first member P1 and second member P2 are parts of a finished product such as an electronic component. First member P1 and second member P2 are picked up by, for example, a feed head (not illustrated), and then, first member P1 is held by head 4 (a joining head), and second member P2 is placed on stage 5.

Here, mark M1 (a second mark) and mark M2 (a third mark) for alignment are provided on first member P1 and second member P2, respectively (details are described later). In Embodiment 1, marks M1, M2, 32a, and 32b are in focus on the image sensor of camera 1. Specifically, the optical path from first member P1 (mark M1) to an edge of lens 2 is defined as L1, the optical path from second member P2 (mark M2) to the edge of lens 2 is defined L2, the optical path from mark 32a on plate 32 to the edge of lens 2 is defined as L3, and the optical path from mark 32b on plate 32 to the edge of lens 2 is defined as L4. In this case, in an arrangement where the optical path end of each of optical paths L1 to L4 is at the focal position of lens 2, marks M1, M2, 32a, and 32b are in focus on the image sensor of camera 1. It should be noted that optical path L1 includes optical path L10 from the edge of lens 2 to half mirror 31a and optical path L11 from half mirror 31a to first member P1 (mark M1). Optical path L2 includes optical path L20 from the edge of lens 2 to half mirror 31b and optical path L21 from half mirror 31b to second member P2 (mark M2). Optical path L3 includes optical path L10, optical path L12 from mark 32a to transmissive surface 31c of prism 31, and optical path L13 from transmissive surface 31c to half mirror 31a. Optical path L4 includes optical path L20, optical path L22 from mark 32b to transmissive surface 31d of prism 31, and optical path L23 from transmissive surface 31d to half mirror 31b.

It should be noted that in Embodiment 1, although marks 32a and 32b are provided on plate 32, only one of mark 32a or mark 32b may be provided.

Monitor 7 displays camera image A captured by camera 1. Camera image A includes first image area A1 and second image area A2. First image area A1 is image data of the side on which head 4 is located, and second image area A2 is image data of the side on which stage 5 is located. As illustrated in FIG. 3, first image area A1 and second image area A2 that are vertically arranged with boundary A3 therebetween are displayed. Boundary A3 is an image corresponding to boundary line 31e between half mirrors 31a and 31b of prism 31. Since prism 31 is so disposed that boundary line 31e matches the X-direction, boundary A3 is positioned at the center of camera image A.

Computation equipment 6 calculates the relative positions of first member P1 and second member P2 on the basis of camera image A output by camera 1, and performs the positioning processing described below.

It should be noted that the optical system is movable in the X-direction and the Y-direction. Moreover, head 4 and stage 5 are movable in the X-direction, the Y-direction, and a direction of rotation around the Z-axis. It should be noted that as long as position correction and a positioning operation for first member P1 and second member P2, which are described below, can be performed, movement directions need not be limited to the above movement directions.

In Embodiment 1, first member P1 and second member P2 (hereinafter, first member P1 and second member P2 may be each referred to as a workpiece) are disposed at the focal position of lens 2, and prism 31 is disposed between lens 2 on the optical axis and each workpiece. Thus, blur appears at boundary A3 of an obtained image. When prism 31 is close to lens 2, blur at boundary A3 of camera image A is large, which decreases the position recognition accuracy of boundary A3. In a system, which is described later, for calculating the relative positions of first member P1 and second member P2 on the basis of boundary A3, a decrease in the position recognition accuracy of boundary A3 leads to a decrease in the positioning accuracy of first member P1 and second member P2. Thus, in the present disclosure, prism 31 is disposed very close to first member P1 and second member P2. Specifically, prism 31 is so disposed that the distance between prism 31 and each of first member P1 and second member P2 is less than the distance between prism 31 and lens 2. In this way, it is possible to decrease blur at boundary A3. Moreover, it is possible to decrease the distance between the relative positions of first member P1 and second member P2.

### (Operation of Positioning Device)

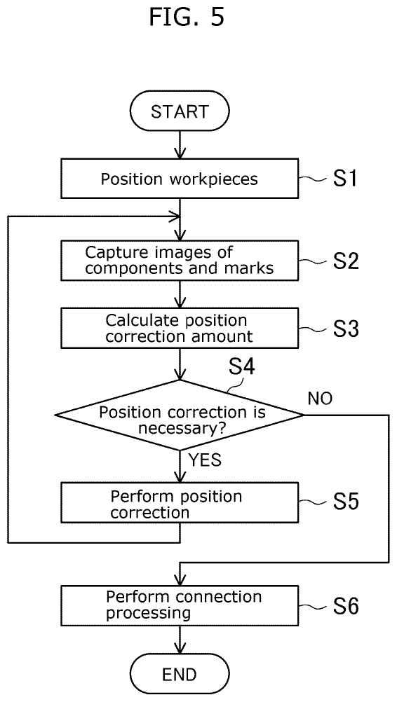

FIG. 5 is a flowchart for explaining an operation of positioning device 10 according to Embodiment 1.

First, workpieces are positioned in positioning device 10 (step S1). Specifically, by using the feed head (illustration is omitted), first member P1 is held by head 4, and second member P2 is held by stage 5. At this time, marks M1 and M2 used in alignment are on the surfaces of first member P1 and second member P2. First member P1 is held by head 4 and second member P2 is placed on stage 5 such that marks M1 and M2 face each other. It should be noted that when positioning device 10 is used in a mounting apparatus such as a flip chip bonder, first member P1 is picked up by the feed head, then vertically inverted, and held by head 4 (joining head).

Camera 1 captures images of first member P1 (mark M1), second member P2 (mark M2), and marks 32a and 32b (step S2). Specifically, camera 1, lens 2, and prism 31 (the optical system) are moved to dispose prism 31 between first member P1 (head 4) and second member P2 (stage 5). Then, camera 1 outputs, to computation equipment 6, camera image A showing first member P1 (mark M1), second member P2 (mark M2), and marks 32a and 32b. It should be noted that camera 1 may capture first image area A1 and second image area A2 separately or simultaneously. For instance, when first image area A1 and second image area A2 are captured at the same time, one of the images may turn white or black. When image capturing conditions, such as lighting luminance, shutter speed, camera gain, and the ratio of coaxial light to oblique light, differ between first image area A1 and second image area A2, camera 1 may capture first image area A1 and second image area A2 separately. Moreover, if clear images of marks 32a and 32b cannot be obtained when performing simultaneous image capturing of marks M1, M2, 32a, and 32b, marks 32a and 32b may be captured in the first image capturing, and marks M1 and M2 may be captured in the second image capturing. Moreover, marks 32a and 32b may be captured in the first image capturing, mark M1 may be captured in the second image capturing, and mark M2 may be captured in the third image capturing. That is, some or all of marks M1, M2, 32a, and 32b may be captured separately or simultaneously. When some or all of marks M1, M2, 32a, and 32b are captured separately, the order of image capturing may be set to any order.

It should be noted that in step S2 described above, images of marks 32a and 32b may be captured before disposing first member P1 above the optical system and second member P2 below the optical system. Then, first member P1 and second member P2 may be respectively disposed above and below the optical system, and images of first member P1 and second member P2 may be captured. This enhances the productivity of the product.

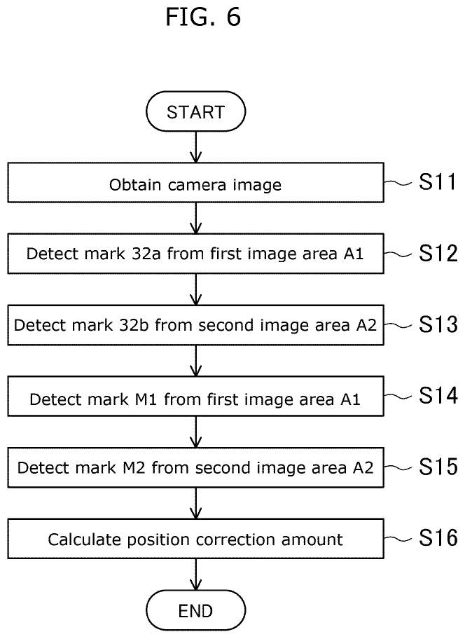

Computation equipment 6 determines the relative positions of first member P1 and second member P2 on the basis of marks M1, M2, 32a, and 32b included in one camera image A or a plurality of camera images A, and calculates the position correction amount of first member P1 and second member P2 (step S3). Specifically, the processing illustrated in FIG. 6 is performed (details are described later).

Computation equipment 6 determines whether position correction is necessary on the basis of the calculated position correction amount (step S4). When the position correction amount is greater than or equal to a predetermined value, computation equipment 6 determines that position correction is necessary (Yes in step S4), and corrects at least one of the position of first member P1 or the position of second member P2 (moves at least one of first member P1 or second member P2) in accordance with the position correction amount calculated in step S3 (step S5). Then, the procedure returns to step S2.

Meanwhile, when the position correction amount is less than the predetermined value, computation equipment 6 determines that position correction is not necessary (No in step S4), and performs connection processing for connecting first member P1 and second member P2 (step S6). Specifically, head 4 is moved toward stage 5 in the Z-direction to connect first member P1 to second member. In this case, when positioning device 10 is used in a mounting apparatus, as step S6 (the connection processing), a mounting operation is performed in which first member P1 (chip component) is placed onto second member P2 (substrate) by moving head 4 (joining head), and first member P1 is mounted onto second member P2.

### (Calculation of Position Correction Amount)

FIG. 6 is a flowchart illustrating processing for calculating a position correction amount according to Embodiment 1. FIG. 6 illustrates the processing that computation equipment 6 performs to calculate the position correction amount in step S3. First, computation equipment 6 obtains camera image A (step S11), and then detects mark 32a from first image area A1 of camera image A (step S12). Moreover, computation equipment 6 detects mark 32b from second image area A2 of camera image A (step S13).

Computation equipment 6 detects mark M1 on first member P1 from first image area A1 (step S14). Moreover, computation equipment 6 detects mark M2 on second member P2 from second image area A2 (step S15). It should be noted that marks M1, M2, 32a, and 32b may be any kinds of marks and need not be specific marks as long as they can be used for alignment. For instance, marks M1 and M2 may be characteristic portions (such as corners) of the corresponding members and may be, for example, marks on the surfaces of the members. For instance, marks M1 and M2 may be marks, electrodes, and portions of the members.

It should be noted that when camera 1 performs image capturing more than one time and a plurality of camera images A are obtained, in steps S12 to S15, computation equipment 6 detects marks M1, M2, 32a, and 32b from among the plurality of camera images A. Moreover, steps S12 to S15 may be performed in any order.

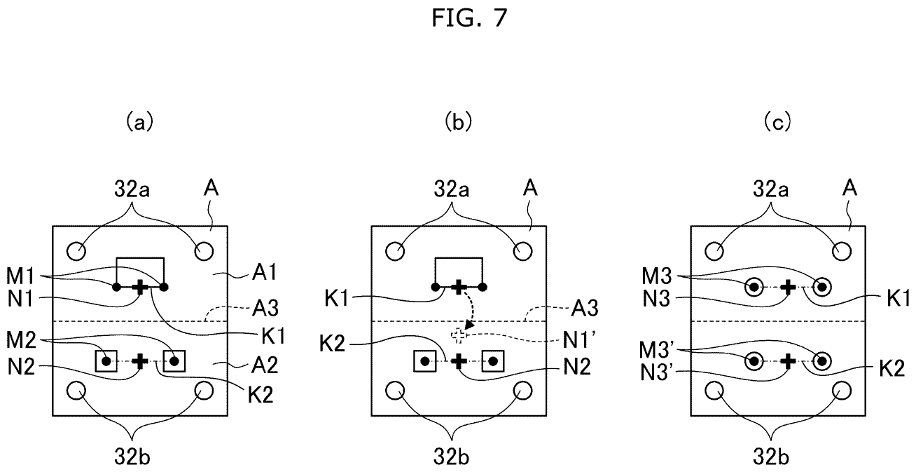

Then, computation equipment 6 calculates the position correction amount on the basis of marks M1, M2, 32a, and 32b (step S16). Hereinafter, the processing for calculating a position correction amount performed by computation equipment 6 in step S16 is described with reference to (a) to (c) in FIG. 7.

(a) to (c) in FIG. 7 are examples of camera image A for explaining the processing for calculating a position correction amount according to Embodiment 1. In (a) to (c) in FIG. 7, mark M1 is a corner of first member P1, mark M2 is a quadrilateral mark, marks 32a and 32b are circular, marks M3 and M3′ (fourth marks) provided on a position correction jig (details are described later) are circular. Moreover, two each of marks M1, M2, 32a, 32b, M3, and M3′ are provided.

In (a) in FIG. 7, computation equipment 6 detects the middle point between two marks M1 as reference position N1 of first member P1, and detects the middle point between (the central points of) two marks M2 as reference position N2 of second member P2. Moreover, computation equipment 6 determines a relative angle formed between angle reference line K1 that is the straight line connecting two marks M1 and angle reference line K2 that is the straight line connecting two marks M2. In the example indicated in (a) in FIG. 7, computation equipment 6 calculates the position correction amount in accordance with reference positions N1 and N2 and the relative angle formed between angle reference lines K1 and K2.

The processing for calculating the position correction amount in accordance with reference positions N1 and N2 is described with reference to (b) in FIG. 7. As the position correction amount, computation equipment 6 calculates in which part of second image area A2 reference position N1 detected in first image area A1 is located, that is, calculates in which part of stage 5 head 4 is located when head 4 is moved to the position of stage 5 at the time of image capturing. Specifically, computation equipment 6 detects the coordinates of reference position N1 within first image area A1, and determines, in second image area A2, reference position N1′ corresponding to the detected coordinates of reference position N1. In principle, when camera image A is folded along boundary A3, in second image area A2, reference position N1′ overlays reference position N1 in first image area A1. However, if it is necessary to enhance the position accuracy, the relative positions of the coordinates of first image area A1 and the coordinates of second image area A2 may be measured additionally. In the example indicated in (b) in FIG. 7, the position correction amount is the vector of the difference between reference position N2 and reference position N1′. It should be noted that the position correction amount may be calculated also in consideration of, for example, an offset value such as another measurement error.

Processing for correcting the relative positions of the coordinates of first image area A1 and the coordinates of second image area A2 (a stetting step) is described with reference to (c) in FIG. 7. To obtain camera image A in (c) in FIG. 7, the position correction jig with marks M3 and M3′ thereon is held by head 4, and the optical system is moved to a predetermined position where camera 1 captures first image area A1 of camera image A. Then, the optical system is caused to retreat, avoiding interference with head 4. Head 4 is moved downward, and the position correction jig is placed on stage 5. Subsequently, the optical system is moved to the predetermined position again, and camera 1 captures second image area A2 of camera image A. In capturing first image area A1 and second image area A2, camera 1 also captures images of marks 32a and 32b. At this time, auxiliary lighting device 34 may be used if needed to capture images of marks 32a and 32b. Camera image A in (c) in FIG. 7 can be obtained on the basis of captured first image area A1 and second image area A2. It should be noted that the position correction jig is a plate made of glass, for example, and images of provided marks M3 and M3′ can be captured from the front and back surfaces of the position correction jig. Moreover, in Embodiment 1, images are captured in a state where the position correction jig is placed on stage 5. However, if the image capturing position is level with stage 5, the position correction jig may be provided at another location.

Then, computation equipment 6 individually detects, from camera image A in (c) in FIG. 7, mark M3 included in first image area A1 and mark M3′ included in second image area A2. Computation equipment 6 detects the middle point between (the central points of) two marks M3 as reference position N3, and detects the middle point between (the central points of) two marks M3′ as reference position N3′. Computation equipment 6 sets the coordinates of first image area A1 and the coordinates of second image area A2 to match the position of reference position N3 and the position of reference position N3′.

Moreover, computation equipment 6 detects the position of mark 32a included in first image area A1 and the position of mark 32b included in second image area A2. Then, computation equipment 6 calculates the relative position and orientation of mark 32a in first image area A1 and the relative position and orientation of mark 32b in second image area A2. Because of this, when for instance misalignment of the optical axis of the camera occurs due to thermal strain, an image is obtained which has a deviation in the field of view from an image for which the coordinates of first image area A1 and the coordinates of second image area A2 are set. However, since it is possible to correctly calculate the coordinates of first image area A1 and the coordinates of second image area A2 with marks 32a and 32b as references, it is possible to correctly calculate the relative positions of the coordinates of first image area A1 and the coordinates of second image area A2.

As described above, positioning device 10 in processing apparatus 100 according to Embodiment 1 includes prism 31 (the optical element), camera 1, and computation equipment 6. Here, prism 31 includes half mirror 31a (the first half mirror) and half mirror 31b (the second half mirror). When prism 31 is disposed between head 4 and stage 5, half mirror 31a reflects light incident from the direction of head 4 toward camera 1. When prism 31 is disposed between head 4 and stage 5, half mirror 31b reflects light incident from the direction of stage 5 toward camera 1. On the basis of light rays incident from prism 31, camera 1 captures camera image A including first image area A1, which is image data of the side on which head 4 is located, second image area A2, which is image data of the side on which stage 5 is located, and images of marks 32a and 32b (the first marks). Marks 32a and 32b are provided at positions that are seen through half mirror 31a and half mirror 31b, respectively, when viewed from camera 1. Computation equipment 6 determines the positions of first member P1 and second member P2 with the positions of marks 32a and 32b as references on the basis of camera image A. Because of this, since marks 32a and 32b are provided at the positions that are seen through half mirror 31a and half mirror 31b when viewed from camera 1, even if each part of the positioning device thermally expands, it is possible to adjust the optical axis (imaging direction) of camera 1 with marks 32a and 32b as references. Accordingly, it is possible to suppress the positioning accuracy from decreasing.

It should be noted that a method for calculating a position correction amount is not limited to the above method. The method for calculating the position correction amount may be appropriately changed in the following manner. For instance, computation equipment 6 records in advance the relative positions and orientations of marks 32a and 32b and the relative positions and orientations of reference positions N3 and N3′. At the timing of connecting first member P1 and second member P2, the relative positions of the coordinates of first image area A1 and the coordinates of second image area A2 are calculated. Moreover, mark M3 and mark M3′ may differ in terms of shape and quantity.

Moreover, only one of mark 32a or 32b may be provided. In this case, if for instance only mark 32a can be captured in first image area A1, the coordinates of second image area A2 may be calculated on the basis of the position of mark 32a.

Moreover, first member P1 (or second member P2) may be too large in size and extend beyond first image area A1 (or second image area A2). In this case, the optical system may be properly moved in the X-direction and the Y-direction, a plurality of camera images A may be generated, and computation equipment 6 may detect mark M1 (or mark M2) on the basis of the plurality of camera images A.

### Embodiment 2

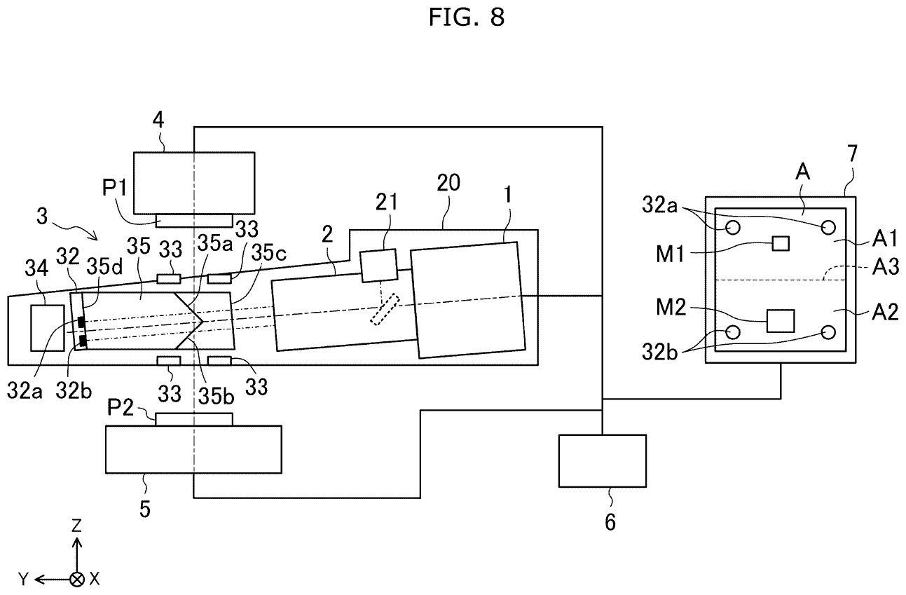

FIG. 8 is a side view of a positioning device according to Embodiment 2. The positioning device illustrated in FIG. 8 has a configuration almost the same as the configuration illustrated in FIG. 1. However, prism 35 is disposed instead of prism 31. Moreover, plate 32 is attached to transmissive surface 31d of prism 35.

Specifically, prism 35 includes half mirrors 35a and 35b, transmissive surface 35c (a second transmissive surface), transmissive surface 35d (a third transmissive surface). Transmissive surface 35c is the surface of prism 35 on the side where camera 1 and lens 2 are positioned. Transmissive surface 35c is perpendicular to the optical axis of lens 2. Transmissive surface 35c transmits light rays incident from the direction of half mirrors 35a and 35b toward camera 1 and lens 2.

Transmissive surface 35d is the surface of prism 35 on the side where plate 32 is positioned, and transmits light incident from the direction of plate 32 toward camera 1 and lens 2.

Half mirror 35a reflects light incident from first member P1 (the direction of head 4) toward camera 1 and lens 2, and transmits light incident from the direction of plate 32 through transmissive surface 35d. Half mirror 35b reflects light incident from second member P2 (the direction of stage 5) toward camera 1 and lens 2, and transmits light incident from the direction of plate 32 through transmissive surface 35d.

Also in Embodiment 2, as with Embodiment 1, marks M1, M2, 32a, and 32b are in focus on the image sensor of camera 1. That is, each of an optical path from first member P1 (mark M1) to an edge of lens 2, an optical path from second member P2 (mark M2) to the edge of lens 2, an optical path from mark 32a on plate 32 to the edge of lens 2, and an optical path from mark 32b on plate 32 to the edge of lens 2 is so configured as to form an image on the image sensor of camera 1.

With the above configuration, transmissive surface 35c of prism 35, which is the surface on the side where camera 1 and lens 2 are positioned, is perpendicular to the optical axis of lens 2. Thus, there is no need to take into consideration refraction when light passes through transmissive surface 35c at the time of image capturing by camera 1. Moreover, since prism 35 and plate 32 can be provided as a single structure, it is possible to further decrease an error due to thermal strain.

### Embodiment 3

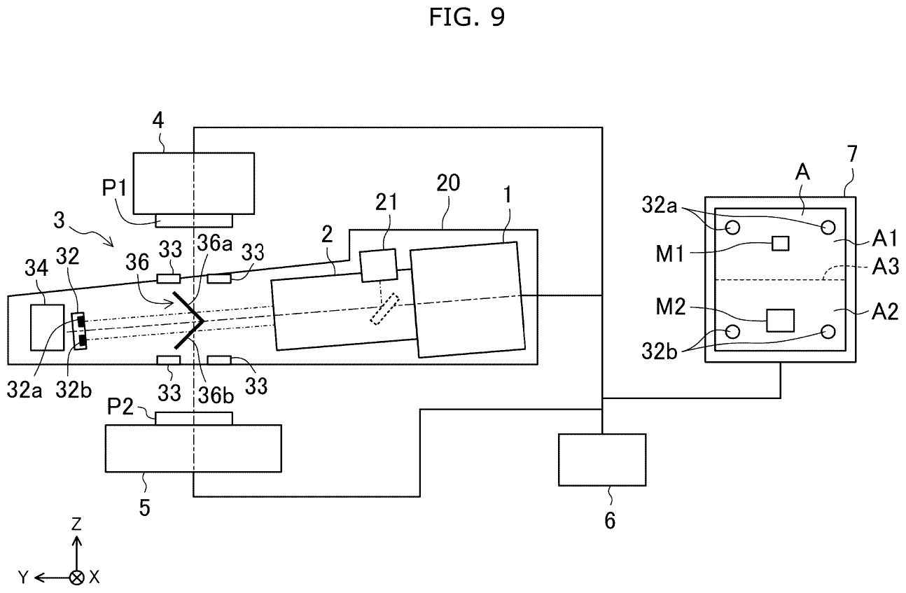

FIG. 9 is a side view of a positioning device according to Embodiment 3. The positioning device illustrated in FIG. 9 has almost the same configuration as the configuration illustrated in FIG. 1. However, half mirrors 36a and 36b are disposed as optical element 36 instead of prism 31. It should be noted that half mirrors 36a and 36b may be configured as a single half mirror or a plurality of half mirrors. It should be noted that half mirrors 36a and 36b have thin plate-like shapes, and are so disposed as to be approximately perpendicular to each other.

Specifically, half mirror 36a reflects light incident from first member P1 (the direction of head 4) toward camera 1 and lens 2, and transmits light incident from the direction of plate 32. Half mirror 36b reflects light incident from second member P2 (the direction of stage 5) toward camera 1 and lens 2, and transmits light incident from the direction of plate 32.

Also in Embodiment 3, as with Embodiment 1, marks M1, M2, 32a, and 32b are in focus on the image sensor of camera 1. That is, each of an optical path from first member P1 (mark M1) to an edge of lens 2, an optical path from second member P2 (mark M2) to the edge of lens 2, an optical path from mark 32a on plate 32 to the edge of lens 2, and an optical path from mark 32b on plate 32 to the edge of lens 2 is so configured as to form an image on the image sensor of camera 1.

As with the configuration described above, by using a half mirror instead of a prism, it is no longer necessary to take into consideration, for example, changes in the aberration and the optical path length when light is passing through the prism, which in turn can simplify the configuration of the optical system. Moreover, when the field of view of the optical system becomes smaller, it becomes unnecessary to use an area near where half mirrors 36a and 36b are in contact with each other, which makes it possible to perform position correction without being affected by the thicknesses of half mirrors 36a and 36b.

### Embodiment 4

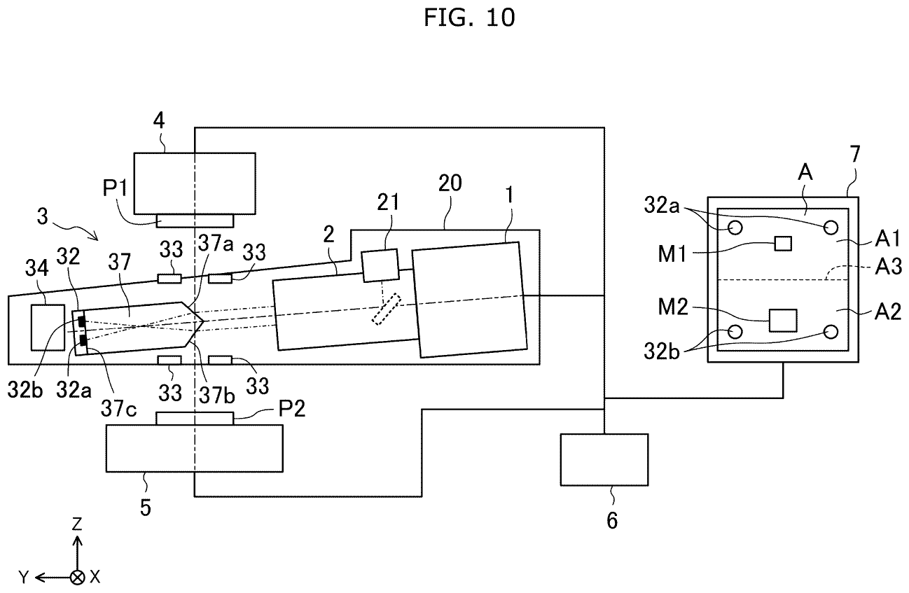

FIG. 10 is a side view of a positioning device according to Embodiment 4. The positioning device illustrated in FIG. 10 has almost the same configuration as the configuration illustrated in FIG. 1. However, prism 37 is disposed instead of prism 31. Moreover, plate 32 is attached to transmissive surface 37c (a fourth transmissive surface) of prism 37. It should be noted that if marks 32a and 32b can be provided on transmissive surface 37c, plate 32 is not necessary. Moreover, as long as images of marks 32a and 32b can be captured, transmissive surface 37c may have any shape. For instance, transmissive surface 37c may have a flat surface or a curved surface having an inclination relative to the imaging direction of camera 1 (the optical axis of lens 2).

Prism 37 includes half mirrors 37a and 37b and transmissive surface 37c.

Transmissive surface 37c is the surface of prism 37 on the side where plate 32 is positioned, and transmits light incident from the direction of plate 32 toward camera 1 and lens 2.

Half mirror 37a reflects light incident from first member P1 (the direction of head 4) toward camera 1 and lens 2, and transmits light incident from the direction of plate 32 through transmissive surface 37c. Half mirror 37b reflects light incident from second member P2 (the direction of stage 5) toward camera 1 and lens 2, and transmits light incident from the direction of plate 32 through transmissive surface 37c.

Also in Embodiment 4, as with Embodiment 1, marks M1, M2, 32a, and 32b are in focus on the image sensor of camera 1. That is, each of an optical path from first member P1 (mark M1) to an edge of lens 2, an optical path from second member P2 (mark M2) to the edge of lens 2, an optical path from mark 32a on plate 32 to the edge of lens 2, and an optical path from mark 32b on plate 32 to the edge of lens 2 is so configured as to form an image on the image sensor of camera 1.

Since the above configuration can simplify the configuration of prism 37, processing of prism 37 is facilitated, and the manufacturing cost of prism 37 can be reduced. Moreover, when capturing images of marks 32a and 32b, lens 2 focuses light rays that have been refracted and passed through half mirrors 37a and 37b. Thus, aberration occurs. Embodiment 4 is useful when such aberration is within a permissible range.

### Embodiment 5

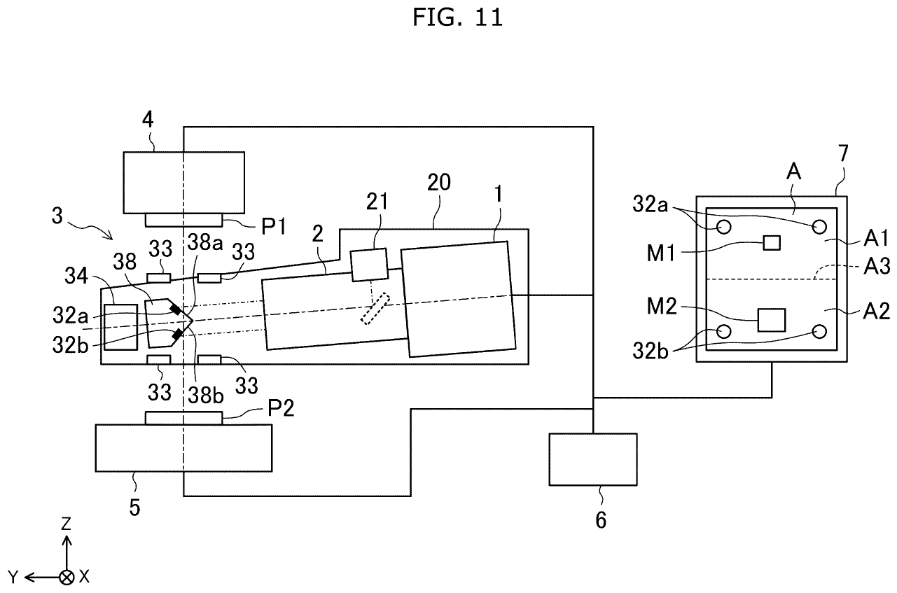

FIG. 11 is a side view of a positioning device according to Embodiment 5. The positioning device illustrated in FIG. 11 has almost the same configuration as the configuration illustrated in FIG. 1. However, prism 38 is disposed instead of prism 31. Moreover, plate 32 is omitted, and marks 32a and 32b are provided on half mirrors 38a and 38b of prism 38, respectively.

Prism 38 includes half mirrors 38a and 38b.

Half mirror 38a reflects light incident from first member P1 (the direction of head 4) toward camera 1 and lens 2. Half mirror 38b reflects light incident from second member P2 (the direction of stage 5) toward camera 1 and lens 2.

Since the above configuration can simplify the configuration of light synthesizing section 3, the device is further less susceptible to heat, and it is possible to reduce the manufacturing cost. It should be noted that since marks 32a and 32b are not disposed at the focal position of lens 2, marks 32a and 32b appear blurred in camera image A. However, Embodiment 5 is useful if the amount of blurring of marks 32a and 32b is a permissible amount.

Moreover, in each of the above embodiments, as a non-limiting example, processing apparatus 100 including positioning device 10 is an imprint apparatus. For instance, processing apparatus 100 may be used in various apparatuses and equipment that require alignment between members, such as a processing apparatus and a manufacturing apparatus other than an imprint apparatus.

Moreover, in each of the above embodiments, as a non-limiting example, processing apparatus 100 as the imprint apparatus is used for making bumps on a substrate. Processing apparatus 100 as the imprint apparatus may be used for making a redistribution layer or may be used for making optical members, such as a light guide plate and an antireflection film in a liquid crystal display, optical components, such as a magnetic disk, a micro lens array, and an optical waveguide, a solar battery, a fuel cell member, a biodevice, or a semiconductor device.

It should be noted that the present disclosure also encompasses embodiments obtained by adding various modifications envisioned by those skilled in the art to the above embodiments and embodiments achieved by optionally combining constituent elements and functions in the embodiments as long as the resultant embodiments do not depart from the scope of the present disclosure. Moreover, the present disclosure also encompasses optional combinations of two or more claims that are made, without having technical inconsistency, from the plurality of claims recited in the Claims of the application as originally filed. For instance, when the dependent claims recited in the Claims of the application as originally filed are formed as multiple dependent claims or multi-multi claims depending from all the preceding claims within the bounds of technical consistency, the present disclosure encompasses all the claim combinations included in the multiple dependent claims or multi-multi claims.

### INDUSTRIAL APPLICABILITY

The techniques in the present disclosure can be used in positioning between members.

1. A positioning device that performs positioning of a first component held by a joining head and a second component placed on a stage in mounting the first component onto the second component, the positioning device comprising:
an optical element including a first half mirror and a second half mirror;
a camera; and
computation equipment, wherein
when the optical element is disposed between the joining head and the stage, the first half mirror reflects light incident from a direction of the joining head toward the camera,
when the optical element is disposed between the joining head and the stage, the second half mirror reflects light incident from a direction of the stage toward the camera,
the camera is configured to capture a camera image including a first image area, a second image area, and a first mark, based on light incident from the optical element, the first image area being image data of a side where the joining head is located, the second image area being image data of a side where the stage is located,
the first mark is provided on at least one of the first half mirror or the second half mirror or is provided at a position seen through at least one of the first half mirror or the second half mirror when viewed from the camera, and
the computation equipment determines, based on the camera image, a position of the first component and a position of the second component with a position of the first mark as a reference.

2. The positioning device according to claim 1, wherein
each of the first half mirror and the second half mirror
selectively transmits and reflects light based on a wavelength, or
transmits and reflects light depending on a polarization direction.

3. The positioning device according to claim 1, wherein
an angle formed between the first half mirror and the second half mirror is an approximately right angle, and
an angle formed between the first half mirror and an optical axis of the camera approximately matches (45+0.5 φ) degrees, and an angle formed between the second half mirror and the optical axis of the camera approximately matches (45−0.5 φ) degrees, where q is an angle of the optical axis of the camera relative to a mounting plane of the second component.

4. The positioning device according to claim 1, further comprising:
at least one of a first light source or a second light source that irradiates with light at least one of the first component held by the joining head or the second component placed on the stage, wherein
the first light source is a coaxial lighting device from which light that is to be made coaxial with an optical axis of the camera is emitted, and
the second light source is an oblique lighting device that emits light with an angle of inclination relative to a direction from the optical element toward the first component and a direction from the optical element toward the second component.

5. The positioning device according to claim 1, further comprising:
a plate with the first mark thereon disposed on an opposite side from the camera relative to the optical element; and
a third light source that is disposed at a light emittable position on an opposite side from the camera relative to the plate and, irradiates the plate with light.

6. The positioning device according to claim 1, further comprising:
a lens disposed between the camera and the optical element, wherein
a distance between the optical element and each of the first component and the second component is less than a distance between the optical element and the lens.

7. The positioning device according to claim 1, wherein
the optical element includes at least two first transmissive surfaces formed on a surface on an opposite side from the camera, and
the at least two first transmissive surfaces each include a curved surface or a flat surface having an inclination relative to an optical axis of the camera.

8. The positioning device according to claim 1, wherein
the optical element includes a second transmissive surface and a third transmissive surface, the second transmissive surface being closer to the camera than the first half mirror and the second half mirror are, the third transmissive surface being on an opposite side from the camera relative to the first half mirror and the second half mirror.

9. The positioning device according to claim 1, wherein
the first mark is provided on a surface of the optical element on an opposite side from the camera.

10. The positioning device according to claim 1, wherein
the optical element includes the first half mirror and the second half mirror each having a thin plate-like shape, and
the first half mirror and the second half mirror are approximately perpendicular to each other.

11. The positioning device according to claim 1, wherein
the optical element includes a fourth transmissive surface on an opposite side from the camera relative to the first half mirror and the second half mirror, and
the fourth transmissive surface is a curved surface or a flat surface.

12. The positioning device according to claim 11, wherein
the first mark is provided on the fourth transmissive surface.

13. A positioning method using the positioning device according to claim 1, the positioning method comprising:
a first holding process for causing the joining head to hold the first component;
a first placing process for placing the second component on the stage;
a locating process for locating the optical element between the joining head and the stage;
a first capturing process for capturing, by the camera, the camera image including the first component, the second component, and the first mark; and
a correction process in which the computation equipment determines, based on the camera image, a position of the first component and a position of the second component with a position of the first mark as a reference, wherein
in the correction process, the computation equipment corrects at least one of the position of the first component or the position of the second component in consideration of misalignment of an optical axis of the camera, based on the position of the first mark included in the camera image.

14. A processing apparatus comprising:
a head;
a stage;
a positioning device that performs positioning of a first member held by the head and a second member held by the stage in connecting the first member to the second member;
an optical element including a first half mirror and a second half mirror;
a camera; and
computation equipment, wherein
when the optical element is disposed between the head and the stage, the first half mirror reflects light incident from a direction of the head toward the camera,
when the optical element is disposed between the head and the stage, the second half mirror reflects light incident from a direction of the stage toward the camera,
the camera is configured to capture a camera image including a first image area, a second image area, and a first mark, based on light incident from the optical element, the first image area being image data of a side where the head is located, the second image area being image data of a side where the stage is located,
the first mark is provided on at least one of the first half mirror or the second half mirror or is provided at a position seen through at least one of the first half mirror or the second half mirror when viewed from the camera, and
the computation equipment determines, based on the camera image, a position of the first member and a position of the second member with a position of the first mark as a reference.

15. A processing method using the processing apparatus according to claim 14, the processing method comprising:
a first holding process for causing the head to hold the first member;
a second holding process for causing the stage to hold the second member;
a locating process for locating the optical element between the head and the stage;
a first capturing process for capturing, by the camera, the camera image including the first member, the second member, and the first mark; and
a correction process in which the computation equipment determines, based on the camera image, a position of the first member and a position of the second member with a position of the first mark as a reference, wherein
in the correction process, the computation equipment corrects at least one of the position of the first member or the position of the second member in consideration of misalignment of an optical axis of the camera, based on the position of the first mark included in the camera image.
